(19) United States
(12) Patent Application Publication
(10) Pub. No.: US 2005/0232267 A1
(43) Pub. Date: Oct. 20, 2005

(54) Method and apparatus providing for linked refreshing of message content

(75) Inventor: Miraj Mostafa, Tampere (FI)

Correspondence Address: HARRINGTON & SMITH, LLP, 4 RESEARCH DRIVE, SHELTON, CT, 06484-6212, US

(73) Assignee: Nokia Corporation

(21) Appl. No.: 11/109,221

(22) Filed: Apr. 18, 2005

Related U.S. Application Data
(60) Provisional application No. 60/563,182, filed on Apr. 16, 2004.

(51) Int. Cl. H04L 12/54; H04L 12/56

(52) U.S. Cl. 370/389; 370/428

(57) ABSTRACT

Disclosed is a method, an apparatus and a computer program to uniquely link a current message to a previous message having content related to content of the current message. The invention features a step, circuitry and computer program to include a unique identification of the previous message as part of the current message, and to further include information in the current message that specifies a disposition of at least one of the previous message and the current message after receipt of the current message The specified disposition may include a deletion of the previous message and/or display to a user of the current message. The current and previous messages may be Multimedia Messaging Service (MMS) messages, the unique identification may include a Message ID of the previous MMS message, and a MMS message recipient may be a MMS Client that may be a mobile terminal. The specified disposition may be overridden by a user of the mobile terminal.

### CLAIM OF PRIORITY FROM COPENDING PROVISIONAL PATENT APPLICATION

This patent application claims priority under 35 U.S.C. §119(e) from Provisional Patent Application No.: 60/563,182, filed Apr. 16, 2004, the disclosure of which is incorporated by reference herein in its entirety.

### TECHNICAL FIELD

This invention relates generally to message formats and procedures and, more specifically, relates to Multimedia Messaging Service message formats and procedures used in wireless communication systems having wireless communication terminals, also referred to, by example, as mobile stations, user equipment, radiotelephones, cellular telephones and personal communicators.

### BACKGROUND

The following abbreviations are found in this patent application:

| | |
|---|---|
| 3GPP | 3rd Generation Partnership Project |
| ID | Identifier |
| MM | Multimedia Message |
| MMS | Multimedia Messaging Service |
| MMSE | a collection of MMS-specific network elements |
| | under control of a single administrator |
| MMBox | Network storage associated with a user into |
| | which MMs, along with MM State and MM Flags, |
| | may be stored, retrieved and deleted |
| Message ID | a unique identifier for a MM |
| OMA | Open Mobile Alliance |
| PDU | Protocol Data Unit |
| TS | Technical Specification |
| VASP | Valued Added Service Provider |

The MMS has been specified for transporting content to a user from a content provider or an application. Reference can be had to 3GPP TS 23.140, V6.5.0 (2004-03), 3^{rd} Generation Partnership Project; Technical Specification Group Terminals; Multimedia Messaging Service (MMS); Functional Description; Stage 2 (Release 6), subsequently referred to herein simply as 3GPP TS 23.140. FIGS. 1, 2 and 3, based on FIGS. 3, 4 and 5, respectively, of 3GPP TS 23.140, are provided to show the MMS reference architecture, the protocol framework to provide MMS, and the interworking of different MMSEs, respectively. The document 3GPP TS 23.140 is incorporated by reference herein.

The MMS has been specified in a way that it should be able to carry content from different services, such as weather updates, news, sports, traffic reports and stock market information. The MMS can be used to convey updates of basically any event/happening to a user. The frequency of update can be substantially constant (static), or it may be dynamically configured by the user or by the service provider depending on the user interest (e.g., a user is interested in receiving traffic reports only when driving), or based on an occurrence of some event (e.g., only when a goal is scored in a football match).

Referring to FIG. 1, an interface (MM7) is specified between a MMS Relay/Server (also referred to as a MMSC) and VASP applications. The MM7 interface provides a means for the delivery of content from service providers. The delivery of content could be based on user subscription (e.g. web-based, customer service). The delivery could also be invoked by a MMS message from a user to the service provider. The means of sending an MMS message to a service provider is also specified by 3GPP TS 23.140. It is also possible for a user to send a MMS message to the service provider to invoke content delivery to a different user.

The process of specifying the use of MMS for transporting data to/from applications is currently an on-going and evolving process. According to recent work in this area, a recipient MMS Client would hand over the content of a specific message to a higher level destination application for processing and presentation, which is expected to further enhance the use of MMS for delivering content to a user from any service provider.

However, a problem and limitation have been identified in the use of MMS for delivering update information to a user. It is typically the case that update content is time sensitive, meaning that it is valid when received, but not necessarily afterwards. As such, it is likely that the receipt of update content would make the previous related content invalid (out of date). Moreover, if the update frequency is high, and if the user is not removing the previous content, the accumulation of update content may occupy valuable memory space in a mobile terminal, such as a cellular telephone or a personal communicator. In practice, there is no utility to be gained by storing out-of-date content in a mobile terminal, where storage space is a valuable resource. It is also not desirable from a user interface point of view to require the user to take repeated actions to delete selected, out-of-date, or soon to be out-of-date, content.

However, in some cases the out-of-date content may be useful for a specific user, such as one who is interested in tracking historical trends. In this case the user may be interested in viewing in sequence related out-of-date messages containing the content of interest. However, as currently specified in 3GPP TS 23.140 there is no absolute way to link a MMS message to a previous, related message.

Network-based refreshing of content is specified for MMS in terms of “replace of MMS” in 3GPP TS 23.140. The use of the replace functionality is very limited, as in this case the content can only be replaced while it is in the MMSC (prior to delivery).

The MMS is delivered on a store-and-forward basis. In most cases a MMS message is stored very briefly (a few seconds or less) in the MMSC prior to delivery. This being the case, the currently specified functionality is not useful for the case of updating content. The network-based solution also imposes extra responsibility on the MMS Relay/Server. Moreover, the user has no control over this functionality, making it less user friendly.

There has been a recent proposal to extend the functionality to the recipient MMS Client (terminal). However, this proposal is based on the source of the message, and not on identifying the exact message to refresh. As a result, the proposal was rejected for inclusion in 3GPP TS 23.140.

### SUMMARY OF THE PREFERRED EMBODIMENTS

The foregoing and other problems are overcome, and other advantages are realized, in accordance with the presently preferred embodiments of this invention.

Disclosed herein is a method, an apparatus and a computer program to uniquely link a current message to a previous message having content related to content of the current message. The invention features a step, circuitry and computer program instructions to include a unique identification of the previous message as part of the current message, and to further include information in the current message that specifies a disposition of at least one of the previous message and the current message after receipt of the current message. As non-limiting examples, the specified disposition may comprise a deletion of the previous message and/or display to a user of the current message.

In a presently preferred, but non-limiting embodiment, the current and previous messages maybe Multimedia Messaging Service (MMS) messages, the unique identification may comprise a Message ID of the previous MMS message, a MMS message recipient may be a MMS Client that comprises a mobile terminal, and a network-based persistent storage may comprise a MMBox. The specified disposition may be overridden by a user of the mobile terminal.

An aspect of this invention also pertains to a data structure embodied on a tangible data storage medium that comprises a linked list of Multimedia Messaging Service (MMS) messages, each except for the first in a temporal sequence of MMS messages comprising an identification of a Message ID of a previous MMS message.

In a further aspect thereof this invention provides a mobile terminal having a receiver and a data processor coupled to a memory that operates under control of a stored program to receive a current message that comprises information to identify a previous message, to store the received current message in the memory along with the previous message, and responsive to information in the current message that specifies an action to be taken for at least one of the previous message and the current message after receipt of the current message, to perform the specified action.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 shows a block diagram of the MMS reference architecture;

FIG. 2 shows the protocol framework to provide MMS;

FIG. 3 shows the interworking of different MMSEs;

FIG. 4 shows a MMS message having first and second additional header elements in accordance with an aspect of this invention;

FIG. 5 shows steps taken by a MMS Client or MMBox upon receipt of a MMS message having the enhanced header format shown in FIG. 4; and

FIG. 6 is a simplified block diagram of a mobile terminal that is suitable for practicing this invention.

### DETAILED DESCRIPTION OF THE PREFERRED EMBODIMENTS

This invention provides a method, an apparatus and a computer program whereby a message can be uniquely linked to a previous message, in the case where the content of both messages is related. An indication of the linkage forms a part of the message that is linked to a previous message. This ensures that the indication arrives at the ultimate destination of the message, where it can be stored. For MMS, a recipient MMS Client can be a mobile terminal, and a network-based persistent storage can be referred to as MMBox. As messages can be stored for a long period of time, the linkage indication can be much more useful and applicable for replacing/refreshing any previous related message.

In more specific terms, the invention operates to uniquely identify a previous message that is linked to a present message. For MMS, the previous message can be uniquely identified by specifying the message ID as a header in the present message. The invention also enables the addition of a further header in a MMS message to indicate any specific suggested action (default behavior) that could be applied on any linked message(s), for example, delete the previous related message, and/or immediately present the new message.

The invention also provides a user activated means (e.g., a terminal setting or a user profile as two non-limiting examples) to overrule the above-mentioned default behavior related to linked messages. For example, a user may be interested in tracking previous information (e.g., stock prices), and thus may wish to override a default deletion of previously received linked MMS messages.

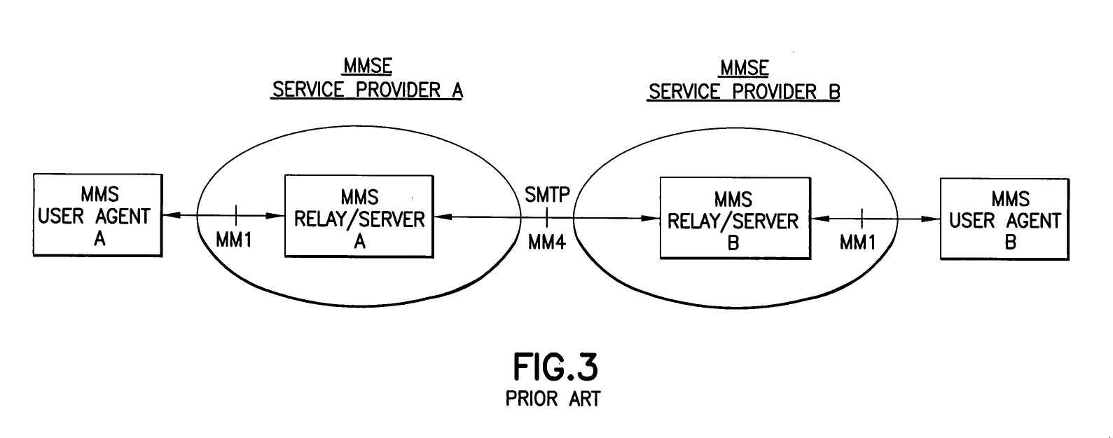

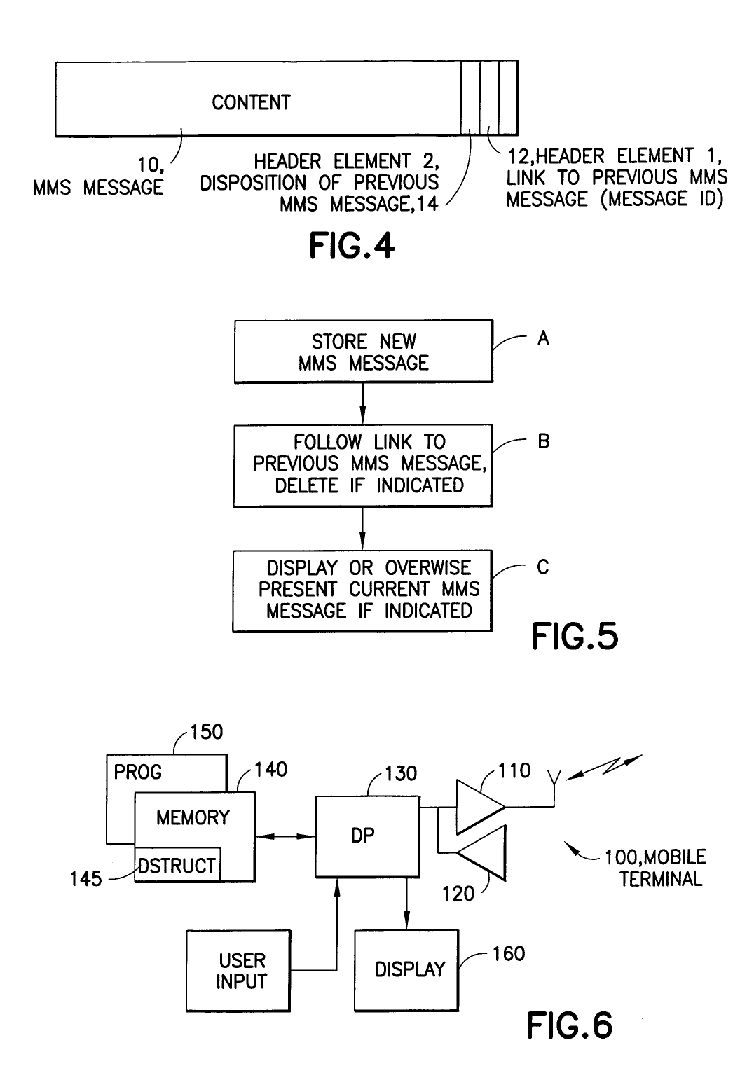

MMS is a particularly good example of a messaging system where the invention can be implemented, although the teachings of this invention should not be construed as being limited to only the case of MMS messages. According to non-limiting embodiments of this invention, and as is shown in FIG. 4, a MMS message 10 that is linked to (logically related to) a previous MMS message contains two additional headers or header elements 12 and 14, where one header element 12 uniquely identifies a previous related MMS message, and where the other header element 14 can contain a value that indicates a suggested action that may be applied to any of the related MMS messages (e.g., delete the previous message, automatically present the new message). The value of the first header 12 is preferably the Message ID of the previous related MMS message, thereby providing a logical link to the earlier MMS message. The second header 14 may assume any reasonable value for identifying a suggested course of action. The possible values can be indicated in combination as well (e.g., either/neither/both delete the previous message, or/nor/and automatically present the new message).

Thus, this invention adds two new optional headers 12 and 14 in the MMS retrieval PDU (MM1_retrieve.RES), as specified in 3GPP TS 23.140. The two new headers 12 and 14 are preferably also added in the MMS notification PDU (MM1_notification.REQ) and the MM4 forwarding PDU (MM4_forward.REQ). It is noted that these particular PDUs are differently named in the OMA MMS specifications.

It is preferred then that the MMS Client and the MMBox are implemented taking the values of the headers 12 and 14 into account, so that the following transaction scenario (refer also to FIG. 5) is the default behavior upon the arrival of any MMS message having the two newly defined headers 12 and 14:
Step A) the new MMS message is stored,
Step B) a linked previous MMS message is deleted (if indicated in the second header 14), and
Step C) the new MMS message is automatically presented (if indicated in the second header 14).

The use of the optional second MMS message header 14 is preferred in the implementation of both MMS Client and the MMBox, as it enables the user to override default behavior in the terminal setting and user profile, respectively.

For the case where a previous MMS message is not deleted with the arrival of a new linked MMS message (one that conveys the Message ID of the earlier MMS message in the first header 12), it is assumed that the linked MMS messages are stored and managed in the MMS Client (e.g., in the mobile station or user terminal) in such a manner that the stored MMS message(s) can be viewed and presented systematically (e.g., sequentially) to the user, or otherwise processed in a manner consistent with a user-desired terminal application. In the case where there are multiple linked MMS messages stored in the MMS Client (or the MMBox) it can be appreciated that the most recently received MMS message header 12 will contain the Message ID of the second most recently received MMS message, that will in turn have a message header 12 that contains the Message ID of the third most recently received MMS message, and so forth. As a result, the plurality of logically related MMS messages can resemble a linked list, with the headers 12 containing backwards (in time) pointers to other logically related MMS messages.

In the case where a previous linked MMS message is unavailable for some reason when the new linked MMS message arrives (e.g., it was already deleted or forwarded), the implementation of both the MMS Client and the MMBox is sufficiently flexible to ignore a command to delete the already deleted MMS message.

If MMS Client is expected to deliver the content of a MMS message to a higher level application, then certain of the above-mentioned implementation issues can be accommodated by the higher level application.

Based on the foregoing it can be appreciated that this invention provides in one aspect for a MMS message refreshing functionality, where the automatic deletion of an outdated and superceded MMS message can be achieved automatically without user involvement, thereby providing improved memory management and an improved user interface in the terminal, or permanent network storage.

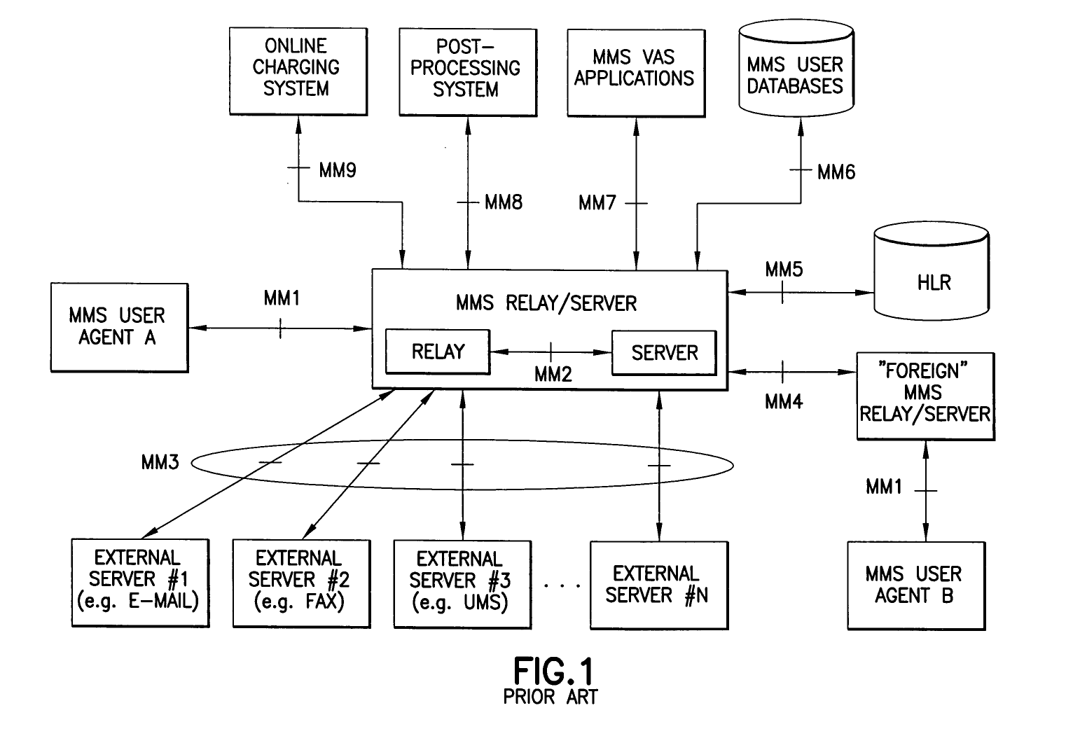

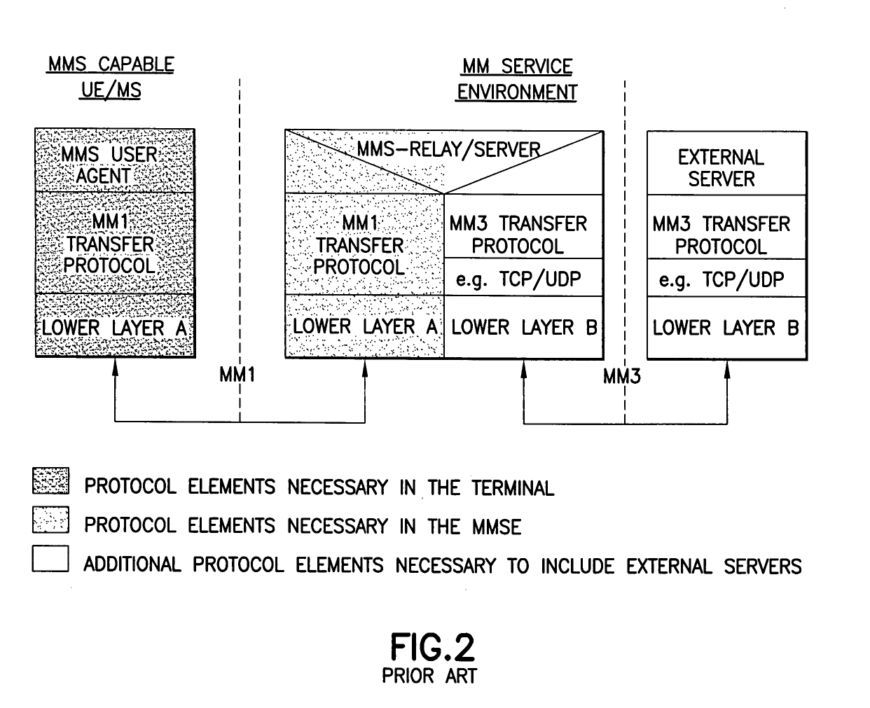

In the preferred embodiment of this invention the MMS Relay/Server (MMSC, see FIG. 1) has no additional responsibility, thereby simplifying in some respects the implementation.

The use of the preferred embodiment of this invention is advantageous, in that it provides a mechanism to uniquely indicate a previous MMS message that is to be replaced/refreshed.

The use of the preferred embodiment of this invention is advantageous, in that it provides a technique to link any new message to any previous message, and thus may be used in the systematic management and presentation of the linked messages to improve the user experience.

The use of the preferred embodiment of this invention is also advantageous in that it provides for the user to override the action(s) dictated by the second message header 14, thereby providing the end user with final control over the handling and disposition of received messages.

This invention can be applied in a number of different messaging systems, and can find particular utility in, but is not limited to, OMA and 3GPP MMS based wireless communication systems.

FIG. 6 shows a mobile terminal 100 that is suitable for sending and receiving messages in accordance with this invention. The mobile terminal 100 includes a wireless radio frequency transmitter 110 and a wireless radio frequency receiver 120, as well as a suitably programmed data processor (DP) 130 coupled to a memory 140. The memory 140 can be any suitable memory, including volatile semiconductor memory and non-volatile semiconductor-based or magnetic media memory, and may be removable. The data processor 130 operates under control of a stored program (Prog) 150 to receive a current message that comprises information to identify a previous message, to store the received current message in the memory 140 along with the previous message, and responsive to information in the current message that specifies an action to be taken for at least one of the previous message and the current message after receipt of the current message, to perform the specified action. In a presently preferred, but non-limiting embodiment the current message and the previous message are Multimedia Messaging Service (MMS) messages, and the identification comprises a Message ID of the previous MMS message. The specified action may be at least one of a deletion of the previous message, and displaying on a display 160 at least some part of the current message. A user input 170 may be, as non-limiting examples, a keypad, a keyboard or a touchscreen display, whereby the user can interact with the stored program for, as one example, overriding a specified disposition of at least one of the current message or a previous message. The messages stored in the memory 140 form a linked list of messages that may be considered to be a data structure (DStruct) 145 that is stored on or in a tangible data storage medium. In other embodiments of apparatus for practicing this invention the wireless transmitter 110 and the wireless receiver 120 maybe replaced by other suitable interfaces for connection to a wired or a wireless (e.g., optical or a low power RF) link

In general, the various embodiments of the mobile terminal 100 may include, but are not limited to, cellular telephones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

The embodiments of this invention may be implemented by computer software executable by a data processor of the mobile terminal 100, such as the DP 130, or by hardware, or by a combination of software and hardware. Further in this regard it should be noted that the various blocks of the logic flow diagram of FIG. 5 may represent program steps, or interconnected logic circuits, blocks and functions, or a combination of program steps and logic circuits, blocks and functions.

The foregoing description has provided by way of exemplary and non-limiting examples a full and informative description of the best method and apparatus presently contemplated by the inventor for carrying out the invention. However, various modifications and adaptations may become apparent to those skilled in the relevant arts in view of the foregoing description, when read in conjunction with the accompanying drawings and the appended claims. As but one example, the use of other similar or equivalent message formats may be attempted by those skilled in the art. Further, other dispositions of the current and/or previous messages(s) may be accomplished. However, all such and similar modifications of the teachings of this invention will still fall within the scope of this invention.

Furthermore, some of the features of the present invention could be used to advantage without the corresponding use of other features. For example, in some applications it may be desirable to provide only the header element 12 to enable a linked list of messages to be generated over time, while the header element 14 is either not provided, or is set to some null (no action) value. As such, the foregoing description should be considered as merely illustrative of the principles of the present invention, and not in limitation thereof.

1. A method, comprising:
linking a current message to a previous message having content related to content of the current message, by
including a unique identification of a previous message as part of a current message; and
providing information in the current message that specifies a disposition of at least one of the previous message and the current message after receipt of the current message.

2. A method as in claim 1, where the current and previous messages are Multimedia Messaging Service (MMS) messages, where the unique identification comprises a Message ID of the previous MMS message, where a MMS message recipient is a MMS Client that comprises a mobile terminal, and where a network-based persistent storage comprises a MMBox.

3. A method as in claim 1, where the specified disposition comprises a deletion of the previous message.

4. A method as in claim 1, where the specified disposition comprises display of the current message.

5. A method as in claim 1, where the specified disposition can be overridden by a user.

6. Apparatus, comprising:
means to uniquely link a current message to a previous message having content related to content of the current message, comprising
means for including a unique identification of a previous message as part of a current message; and
means for providing information in the current message that specifies a disposition of at least one of the previous message and the current message after receipt of the current message.

7. Apparatus as in claim 6, where the current and previous messages are Multimedia Messaging Service (MMS) messages, where the unique identification comprises a Message ID of the previous MMS message, where a MMS message recipient is a MMS Client that comprises a mobile terminal, and where a network-based persistent storage comprises a MMBox.

8. Apparatus as in claim 6, where the specified disposition comprises a deletion of the previous message.

9. Apparatus as in claim 6, where the specified disposition comprises display of the current message.

10. Apparatus as in claim 6, further comprising means for a user of a mobile terminal to override the specified disposition.

11. A computer program embodied on a computer readable medium to link a current message to a previous message having content related to content of the current message, comprising operations of:
including a unique identification of a previous message as part of a current message; and
providing information in the current message that specifies a disposition of at least one of the previous message and the current message after receipt of the current message.

12. A computer program as in claim 11, where the current and previous messages are Multimedia Messaging Service (MMS) messages, where the unique identification comprises a Message ID of the previous MMS message, where a MMS message recipient is a MMS Client that comprises a mobile terminal, and where a network-based persistent storage comprises a MMBox.

13. A computer program as in claim 11, where the specified disposition comprises a deletion of the previous message.

14. A computer program as in claim 11, where the specified disposition comprises display of the current message.

15. A computer program as in claim 12, where the specified disposition can be overridden by a user.

16. A data structure embodied on a tangible data storage medium, comprising a linked list of Multimedia Messaging Service (MMS) messages, each except for the first in a temporal sequence of MMS messages comprising an identification of a Message ID of a previous MMS message.

17. A data structure as in claim 16, where said data storage medium comprises a part of a mobile terminal.

18. A mobile terminal comprising a receiver and a data processor coupled to a memory and operating under control of a stored program to receive a current message that comprises information to identify a previous message, to store the received current message in the memory along with the previous message, and responsive to information in the current message that specifies an action to be taken for at least one of the previous message and the current message after receipt of the current message, to perform the specified action.

19. A mobile terminal as in claim 18, where the current message and the previous message are Multimedia Messaging Service (MMS) messages, and where the identification comprises a Message ID of the previous MMS message.

20. A mobile terminal as in claim 18, where the specified action comprises at least one of a deletion of the previous message and displaying the current message.

21. A mobile terminal as in claim 18, where the specified action is overridden by a user of the mobile terminal.
